(19) United States
(12) Patent Application Publication
(10) Pub. No.: US 2009/0198509 A1
(43) Pub. Date: Aug. 6, 2009

(54) Method and systems for connecting service providers and service purchasers

(76) Inventor: Mark Dumoff, Wayne, NJ (US)

Correspondence Address: FOX ROTHSCHILD LLP;New York, 2000 Market Street, Tenth Floor, Philadelphia, PA, 19103, US

(21) Appl. No.: 12/012,062

(22) Filed: Jan. 31, 2008

(51) Int. Cl. G06Q 50/00; G06Q 10/00; G06Q 30/00

(52) U.S. Cl. 705/2; 705/1; 705/27; 705/14; 705/10

(57) ABSTRACT

Service providers, service purchasers, and interested third parties may link combined expectations, resulting in real insight and greater satisfaction for all involved. A ranking of service providers is obtained from past service purchasers, the ranking comprising emotive satisfaction ratings of pre-selected attributes. Individual profiles for service providers are generated that comprise an emotive satisfaction rating value of pre-selected attributes. An emotive profile is obtained from a potential service purchaser that comprises the potential purchaser's assignment of an importance value to pre-selected attributes, and a list of service providers is provided to the potential service purchasers based on a correlation of the emotive profile and the emotive satisfaction rating values of service providers.

### FIELD OF INVENTION

This invention relates to methods and systems for facilitating communication between service providers, service purchasers and third parties.

### BACKGROUND

As the Internet becomes more popular, searches by service purchasers for service providers on the Internet are replacing word of mouth from friends and family as the preferred approach to finding and choosing the right service provider. Indeed, there has been a proliferation of service provider directory Web sites in the past few years. Some of these sites include basic contact and practice information provided by the service providers. Some have unscientific satisfaction ratings as a major component. Other sites are simply reformatted static phonebook type directories. Unfortunately, these websites fall short in helping consumers to find and connect with service providers based on their individual needs or preferences.

Accordingly, there is a need in the art for a method that helps service purchasers find, compare, choose and contact the right service providers based on compatibility of their personal preferences.

### SUMMARY

In one aspect, a method for facilitating communication between service providers and service purchasers is provided. The method comprises obtaining ranking of service providers by past service purchasers, the ranking comprising emotive satisfaction ratings of pre-selected attributes; generating individual profiles for service providers comprising an emotive satisfaction rating value on pre-selected attributes for the service providers; obtaining from a potential service purchaser an emotive profile comprising the potential service purchaser's assignment of an importance value to pre-selected attributes, and providing a list of service providers to the potential service purchasers based on a correlation of the emotive profile and the emotive satisfaction rating values of service providers.

The method may further comprise, in response to the potential service purchaser selection of a first service provider from the list, displaying an individual profile for the first service provider comprising emotive satisfaction rating values for attributes with the importance value higher than the first threshold value, a video message or enabling the potential service purchaser to contact service providers on the list. The emotive satisfaction rating value of an attribute is calculated by aggregating all emotive satisfaction ratings of that attribute from surveys completed by past consumers.

In some embodiments, the service providers may receive feedback regarding their business practices based on the surveys completed by past service purchasers. In addition, third parties may also be provided with relevant information

In another aspect, a system for facilitating communication between service providers and service purchasers is provided. The system comprises a bus system; a memory connected to the bus system wherein the memory includes a set of instructions; and a processor connected to the bus system, wherein the processor executes the set of instructions stored in memory to perform the steps of the method described above. In addition, a computer-readable medium is provided which has computer instructions to carry out a method as described above.

Yet another aspect provides a method for connecting physicians with potential patients comprising: obtaining emotive satisfaction ratings for pre-selected attributes of physicians from past patients; generating individual profiles for physicians comprising an emotive satisfaction rating value of pre-selected attributes; obtaining from a potential patient an emotive profile comprising the potential patient's assignment of an importance value to pre-selected attributes, and providing a list of physicians to the potential patients based on a correlation of the emotive profile and the emotive satisfaction rating values of compatible physicians. The method may also include steps of providing feedback to the physicians and providing relevant information to third parties.

### BRIEF DESCRIPTION OF THE FIGURES

FIG. 1 presents a flow chart for an embodiment method.

FIG. 2 presents an embodiment list of past service purchasers generated by service providers

FIG. 3 presents a spreadsheet for calculating the emotive satisfaction rating value for service providers.

FIG. 4 presents an embodiment individual profile for a service provider.

FIG. 5 illustrates an embodiment system.

FIGS. 6-14 are screen shots presented by an embodiment system.

### DETAILED DESCRIPTION

A method for facilitating communication between service providers and service purchasers is provided. The method allows the service providers, consumers, and interested third parties to link combined expectations, resulting in real insight and greater satisfaction for all involved. The term “service provider” means an entity or an individual that provides goods or services to other entities or individuals. The methods described herein are particularly suitable for use in services, including, but not limited to, health care services, financial services, insurance providers, accounting services, legal services, home repair and improvement services, and wedding planning services, among many others. The term “service purchaser” refers to individuals or entities that purchase goods or services from the service providers. The term “third parties” means any party that may be interested in utilizing some or all of the data generated while practicing the methods disclosed herein, and that can be legally provided with such data.

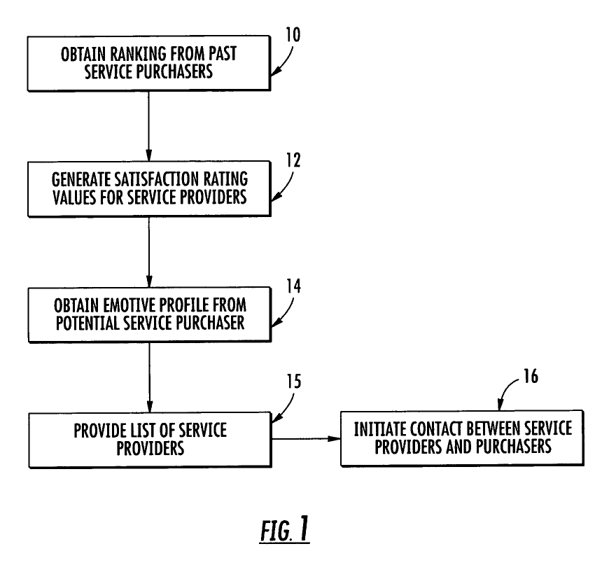

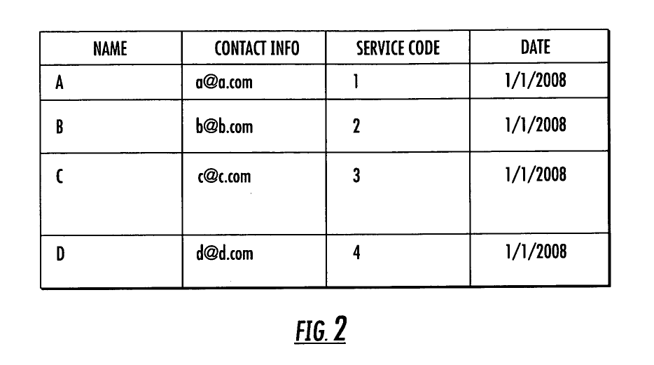

A flow chart for an embodiment method for facilitating communication between service providers and service purchasers is presented in FIG. 1. In step 10, the rankings of service providers are obtained from the past service purchasers. A person with ordinary skill in the art would undoubtedly realize that this can be achieved by various methods. Preferably, a service provider generates a list, such as shown in FIG. 2, where the name of past service purchasers, their contact information, and, potentially, the type of service purchased is provided. Preferably, such information is encrypted by methods known and used in the art to protect service purchasers privacy. Surveys may be sent electronically, by phone or using regular mail to all or some of the past service providers on the list. In one embodiment, the service provider itself may send out the surveys to the past service purchasers. In another embodiment, a practitioner of the method or another entity may send out the survey to the past service purchaser.

The surveys provide the past service purchaser with an opportunity to rate the service providers on different pre-selected attributes. The surveys are preferably scientifically developed surveys based on nationally-recognized guidelines for specific types of services. For example, to determine patient satisfaction with physicians, surveys developed or approved by the National Quality Forum or by the National Committee for Quality Assurance may be utilized. While some of the attributes may be applicable to all types of service providers, other attributes may be selected depending on the type of service provider. For example, returning phone calls promptly is an attribute that is sought after in most service providers, whereas being sensitive to the service purchaser's emotional needs may be more important to purchasers of health care services than for purchasers of home repair services because the purchasers of health care services may be more emotionally vulnerable. Accordingly, the surveys are preferably tailored for the specific types of goods and services to provide potential service purchasers with the most relevant information, as will be described below. When completing the survey, the past service purchasers assign a ranking, referred to here as an emotive satisfaction rating (ESR), to the attributes listed in the survey. This ranking may be a number, a letter, a percent satisfaction, or similar other ranking that ideally enables past service purchasers to express their opinions in a concise, accurate and scientific manner.

In some embodiments, the past service purchasers may be asked to summarize their overall experience with the service provider in addition to ranking the service providers on individual attributes. Oftentimes people are willing to provide quick answers to specific questions, but do not want to take time to answer open ended questions. Accordingly, in the preferred embodiments, the surveys may include a number of phrases that describe a range of overall experiences. Since past service purchasers simply have to check the most applicable phrase, they may be more likely to describe their overall experience than if simply asked to comment on their experience. Suitable phrases may include, but are not limited to, knowledgeable, friendly, true professional; concise, direct, and informative; or experienced, understanding, and instructive. The survey also preferably includes a question whether the past service purchaser would recommend the service provider or would use the service provider again.

Finally, the surveys may ask the past service purchaser to provide additional information. The additional information may include information about the past service purchasers such as date of birth, address, ethnic information, date of visit or similar information. In addition, the past service purchasers may be asked to provide information that may enable the method practitioner to assign weights to the emotive satisfaction values, as will be described in more detail below. Such information may include, but is not limited to, prior history between the service provider and the purchaser, the purchaser's experience with other providers of similar goods and services.

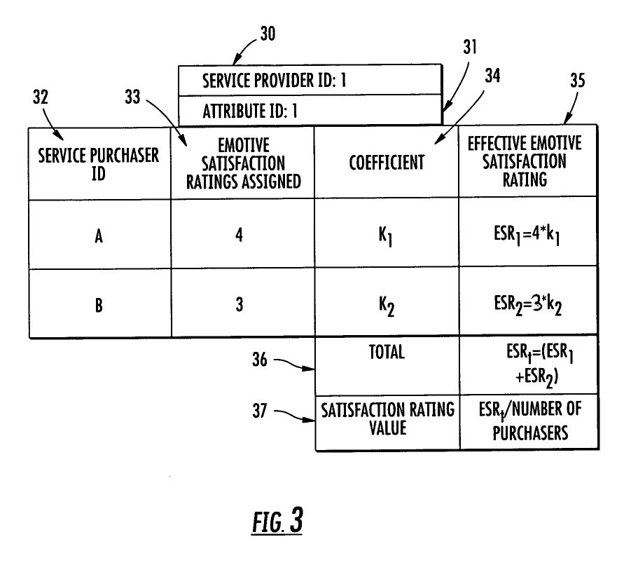

In step 12, an emotive satisfaction rating value (ESRV) on pre-selected attributes is generated for the service providers from the data obtained in step 10. The attributes preferably measure the subjective qualities such as, for example, service provider's demeanor or friendliness of the office personnel, in contrast to more objective characteristics such as, for example, the price the service provider charges or whether the office is open on the weekends. In other words, ESRVs is a subjective representation of the quality of past consumers' experience with a particular service provider. Upon receipt, the surveys from the past service purchasers are analyzed, and the ESRV may be calculated from the surveys using any algorithm known and used in the art for this type of data analysis. Preferably, the surveys are also stored for quality assurance purposes. One example for calculating the ESRV is presented in FIG. 3. A service provider's ID is entered in field 30 and the ID for which the emotive satisfaction rating value is calculated is entered in field 31. Column 32 may include the service purchaser's ID that rated the service provider listed in field 30 on the attributes identified in the field 31. The ESR assigned by the service purchaser to that attribute in the survey is entered in column 33. It is entered directly from the survey obtained in step 10. In some embodiments, if the past service purchaser did not provide a rating to the attribute in question, a pre-set rating may be entered into the column instead of the actual rating. In some embodiment, ESRVs may not be calculated until a minimum number of surveys have been collected to ensure the reliability and validity of the ESRVs. Standard statistical methods may be used to determine the minimum numbers necessary for an accurate result.

Next column 34 includes coefficients for calculating effective ESRVs in column 35. The coefficients correspond to weights to be given to each ESR in the final calculation. In some embodiments, all values may be given the same weight, and thus all coefficients will be set to 1. In such embodiments, the ESRV is simply an average of individual ESR. Alternatively, the ESRV may be a weighted average of individual ESRs. If, for example, it is believed that more recent ESRs present a more accurate assessment of the service provider's characteristics than earlier ones, higher coefficients may be assigned to more recent values. As described above, the surveys may request any information that the method practitioner believes has an affect on the relative accuracy of the ESR. Such information may be used to assign coefficients. It is within the capabilities of one of ordinary skill in the art to determine the values of the coefficients based on information that he or she believes affects the accuracy of the ratings provided by past service purchasers.

The ESRV in field 37 is calculated by dividing the sum of effective ESRs, which can be found in field 36, by the number of the past service purchasers from column 32. As mentioned above, other techniques for calculating the ESRV that is representative of the ratings obtained in step 10 are known and may be used.

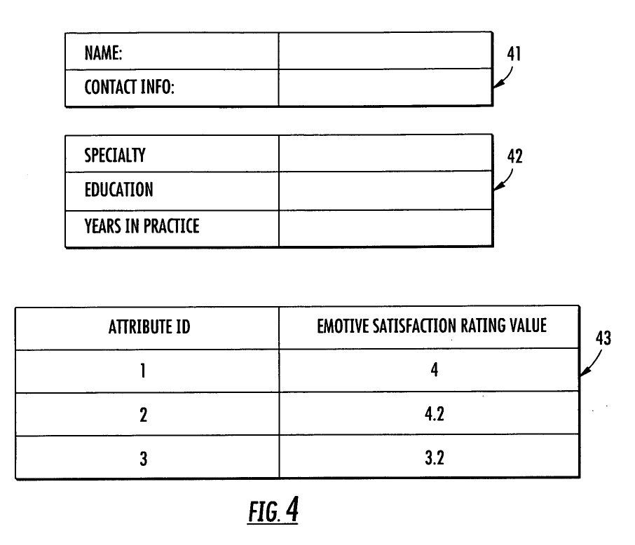

The next step is generating a service provider's individual profiles, one embodiment of which is shown in FIG. 4. In field 41, basic information about the service provider, such as its name and contact information, is displayed. In field 42, information, which may aid the potential service purchaser to make a selection of the service provider, may be entered. Such additional information will be referred herein as a marketing information. Marketing information preferably provides a more objective measure of the service provider's characteristics. Similar to the surveys described above, the additional information that may be collected and displayed in field 42 may include information pertinent to all types of goods and services as well as the information adapted for a specific type of goods or services that are being sought. For example, when choosing a provider of medical services, a potential purchaser may want to know where the physician went to school, the number of years in practice, the size of the practice, which is the type of information a service purchaser would like to know about any service provider. In addition to that information, when looking for a physician, it may be important to know more specific information such as where the physician received his or her training, the physician's credentials, whether the physician is board certified, whether the physician is affiliated with any hospitals, what health insurances are accepted and other similar information. In addition, marketing information may include information about the service provider's business such as when the office is open or whether there is parking or public transportation near the office. Finally, field 43 may include the ESRVs for different attributes.

In preferred embodiments, the ESRVs in the individual profile of a service provider are updated on regular basis to reflect the most recent data. The most recent data may be included into the algorithm for calculations of the ESRVs as described with reference to FIG. 3. It may be given the same or different weight as the previous data. In some embodiments, data collected before a pre-set date may be excluded completely. In addition, if major changes, both improvements and deteriorations, in the service quality are noticed for a service provider, its profile is preferably updated to reflect these changes. This can be easily achieved, for example, by using coefficients or by filtering out data that was obtained before the change.

Referring back to FIG. 1, step 14 includes obtaining from a potential service purchaser a personal profile. Such profile may comprise the potential service purchaser's emotive profile. To obtain such profile, a potential service purchaser typically is presented with a survey that lists a number of attributes of providers of specific goods and services that may affect the potential service purchaser's selection of service provider. In one embodiment, the attributes may be selected to highlight the service provider's subjective characteristics, such as communication style, trust building, availability, environment, ethnic sensitivity, language skills and so forth. These surveys may be similar to the surveys submitted to the past service purchasers in that they may list the same attributes. As stated above, the surveys may be customized depending on the type of goods and services and other considerations. The potential service purchaser creates an emotive profile by ranking how important these pre-selected attributes are to him or her in a service provider. The rank, also referred to here as an importance value, may be a letter, a number, a percentage, etc. Preferably, the importance value is in the same format as the emotive satisfaction rating provided by the past service purchasers.

In addition to assigning an importance value to the subjective attributes, the potential service purchaser's personal profile may also indicate other personally relevant factors and selection criteria that may affect their choices. These personally relevant factors are similar to the additional information that may be included into the service providers' individual profiles, as described in reference to FIG. 4. They may include criteria applicable to providers of all types of goods and services as well as criteria that are only relevant to specific types of goods and services. Examples of such relevant factors include, but are not limited to, location, years in practice, gender, religious affiliations, size of business, etc. Finally, the potential service purchaser's profile may also include its demographic factors, such as for example, race, age, income, disabilities, mobility (in terms of travel time to work or number of vehicles available), educational attainment, home ownership, employment status, and even location. These factors may, in some embodiments, be used as an additional search criteria as well as be used for third parties' purposes as is described below.

In response to submitting the survey, the potential service purchaser is presented with a list of compatible service providers in step 15, indicated in FIG. 1. The list is generated by correlating the emotive profile submitted by the potential service purchaser with the individual profiles of the service providers. Accordingly, the list preferably includes only service providers that have attributes which are valued by the potential service purchaser. In one embodiment, the list may only include service providers with ESRVs for the attributes that potential service purchaser rated at or above a threshold importance value, also referred to herein as relevance value as will be described in more detail below. Thus, there is a high likelihood that the potential service purchaser will be satisfied with the service. Accordingly, the term “compatible” means that the service provider possesses attributes that are valued by the potential service purchaser. In some embodiments, the potential service purchaser's personally relevant factors and additional information from the service provider's profile may be taken into account when generating the list of the service providers.

Correlating of the emotive profile submitted by the potential service purchaser with individual profiles of the service providers may be performed using various techniques, which are well known in the art. For example, the correlation analysis may be performed using a statistical software package such as, for example, STATISTICA developed by StatSoft, Inc., Tulsa, Okla.

By way of a non-limiting example, the correlation may be calculated by finding an average relevance match between the service provider and the service purchaser. First, relevance array is created by selecting the attributes which the potential service purchaser rated above relevance value. Relevance value is a minimum importance value that determines whether an attribute is included into the relevance array. In one embodiment, the importance values may range between 0 (not important) and 5 (extremely important), and the relevance value may be set at 4 (very important). Accordingly, the relevance array may include all attributes that are rated either 4 or 5. Second, the individual profiles of the service providers are searched for the ESRVs of each attribute listed in the relevance array. In some embodiments, only certain individual profiles are searched. For example, the profiles to be searched may include only profiles of service providers that match personally relevant factors indicated by the potential service purchaser.

Third, a relevance percentage is calculated for each attribute listed in the relevance array. Relevance percent is a ratio between the emotive satisfaction rating value received by a particular service provider for a particular attribute and the importance value assigned to that attribute by the potential service purchaser. For example, if the potential service purchaser assigns an importance value of 5 and service provider's ESRV for that attribute is 4.2, the relevance percentage is 84%. Fourth, the average relevance percentage for each service provider is calculated by averaging the relevance percentages for all attributes in the relevance array. Undoubtedly, one with ordinary skill in the art would realize that the average relevance percentage may be calculated using various statistical methods such as, for example, arithmetic mean, weighted mean, geometric mean, and similar.

The average relevance percent may also be referred to herein as a relative match among past service purchasers to the potential service purchaser's most important attributes. Alternatively, the relative match may be limited only to satisfied past service purchasers, i.e. the ones that would recommend their service provider, instead of all past service purchasers. It should also be noted that although the relative match may be a measure of compatibility of service providers and service purchasers, a value of relative match corresponding to what is meant by the term “compatible” may vary depending on many factors, such as for example, the types of services provided, how many past service purchasers recommended that service provider, or whether the potential service purchaser specifies other personal relevant factors. For example, one potential service purchaser may believe that a service provider with a relative match of 40% may be more compatible with him or her than a service provider with a relative match of 80 because the former has the same cultural background as the potential service purchaser.

The list of service providers is displayed with service providers arranged, preferably, according to their average relevance percentage. In case of a tie, the service providers with the same average relevance percent may be displayed based on secondary criteria such as alphabetical order, proximity to potential service purchaser, percent of recommendation by past service purchasers, years in practice, and so on.

After receiving a list of compatible service providers, the potential service purchaser may request to receive more detailed information of a particular service provider. Such information preferably includes the relevance percent for the attributes listed in the relevance array, i.e., the attributes that the potential service purchaser considers important. Other statistical details regarding the service provider may be displayed such as the percentage of past service purchasers who would recommend the particular service provider, the average relevance percentage, or quotations from past service purchasers regarding their opinion about their service provider or about the overall quality of the received goods or services. In addition, the service provider's contact information, and marketing information including, but not limited to, biographical information, and information about the service provider's practice, may be displayed for consideration by the potential service purchaser. A personal message from the service provider may also be included. When the methods disclosed herein are practiced electronically, the personal message may be in a form of web content or a video clip. Seeing a video clip of a service provider provides the potential service purchaser with an opportunity to assess the service provider's style, personality and philosophy. Finally, the method practitioner may include any other information believed to be helpful to the potential service purchaser in selecting the service provider.

In step 16, the potential service purchaser may initiate contact with the service provider selected from the list in step 15. In one embodiment, the potential service purchaser may simply call the service provider. Alternatively, when the method is practiced electronically, the potential service purchaser may send an email to the selected service provider requesting an appointment or a phone call from the service provider. In one embodiment, a form may be provided that allows the potential service purchaser to schedule an appointment, ask questions, specify the type of appointment needed, best time to call, or preferred appointment time. In addition, the potential service purchaser may describe the reasons for seeking the service from the service provider.

In addition to matching potential service purchaser with compatible service providers, the methods described herein may be used to provide the service providers with feedback about their business practices. Scores to inquiries such as whether the office is pleasant and comfortable, whether the office staff is cordial, whether it is easy to communicate with the service provider, etc., may provide service providers with valuable insight into how their practices are seen by their customers. In some embodiments, the service provider may be enabled to track its improvement over time by, for example, requesting scores received during a number of fixed periods of time. In another embodiment, the service provider may request the aggregate scores to see whether the service provider consistently performs at a high level. One of ordinary skill in the art would undoubtedly realize that the collected data may also be manipulated in a variety of other ways to produce feedback in a form most useful to service providers.

In some embodiments, the method may provide service providers with tools necessary to improve its practice. For example, embodiment methods may allow the service provider to compare its results with results in similar categories received by other service providers. Also, a searchable library of best practices that can present service provider with ideas on how to improve certain attributes of its practice may be made available to interested service providers.

The methods described herein may also be easily utilized to provide information to third parties. For example, malpractice insurance companies may be interested in ensuring that the service providers covered by their insurance provide a high quality service and consistently achieve a high level of customer satisfaction. In another example, an employer that subsidizes its employees' purchases of services from service providers may want to ensure that the employees are satisfied with the quality, accessibility, and type of subsidized service. The data provided to third parties may be the same data as provided to service providers or service purchasers, or it may be customized depending on the needs of the third party or relation between the third party and the service purchasers or providers.

In one embodiment, methods disclosed herein may also be used by third parties for post-market monitoring or direct advertisement of their products. Oftentimes, service providers resell goods or services manufactured by third parties. The third parties, however, may find themselves hard-pressed to obtain feedback about their products from end-users due to lack of direct relationship between the end-users and the third parties. In addition, end-users may be unwilling to provide feedback about their experience with the third party's goods or services even when asked for it by the service provider. This may happen for a variety of reasons ranging from end-user's lack of time to breakdown in communication between the end-users and service providers. The methods described herein are designed to improve customer satisfaction with the goods and services received and build lasting personal relationships between service providers and service purchasers. A satisfied customer who has a personal relationship with the service provider may be more likely to respond to follow up surveys regarding from that service provider. In addition, satisfied customers may be more willing to consider information received from the service providers such as additional instructions for use, product warning, product updates, advertisement of related products, and so on. Accordingly, one embodiment method may include a step of enabling a third party to obtain post-market monitoring of its goods or services. Additionally, the third parties may use demographic factors provided by potential service purchasers for targeted direct advertisement.

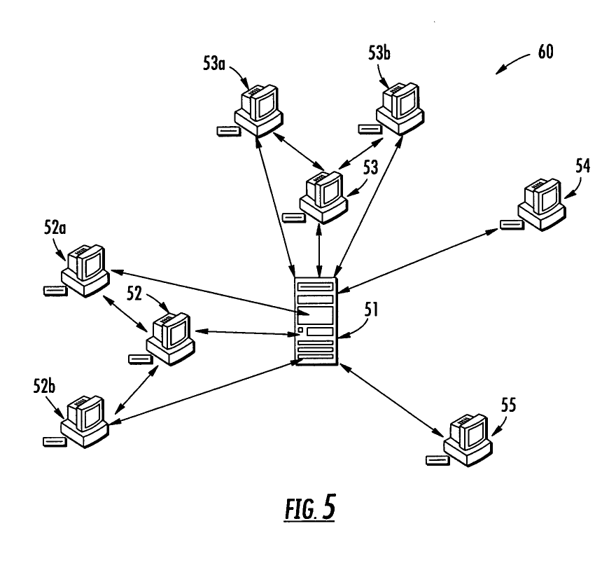

Preferably, the methods described herein are performed using a system 50 presented in FIG. 5. The system 50 connects via a communication network a method practitioner's server 51, and remote users such as service providers 52 and 53, past consumers 52a, 52b, 53a and 53b, a potential service purchaser 54, and, potentially, a third party 55. The server 51 may comprises a bus, a memory device connected to the bus, a processor connected to the bus, and an I/O interface connected to the bus for connecting the server 51 to external devices. The memory device may be an external or internal memory device such as RAM, ROM, Hard Drive, CD-ROM, or DVDs. The memory device may also store computer-readable instructions for the processor to execute the steps of an embodiment method. The instructions may be written in any known programming language and converted to a language readable by the server 51. Other information such as individual profiles of service providers, additional information about service providers, emotive profiles and personally relevant factors of service purchasers, and surveys, may also be stored on the server 51.

Suitable communication networks for communication between the server and the remote units include, but are not limited to, the Internet, an intranet, an extranet, a virtual private network (VPN) and non-TCP/IP based networks. The remote users may communicate with the server through electronic devices that include, but are not limited to, desktop personal computer, workstations, web enabled telephones or cellular telephones, personal digital assistants (PDA), laptops, or any other devices capable of interfacing with a communications network.

The service providers 52 and 53 may electronically send a survey to past service purchasers 52a and 52b, and 53a and 53b, respectively. As described above, instead of having the service provider send out the survey directly, the surveys may be sent out by the server 51, a third party 55 or by some other entity. (not shown). The past service purchasers 52a, 52b, 53a, and 53b may forward the completed surveys either directly to the server 51 or to another entity (not shown) which would in turn forward the surveys to the server 51. Upon receipt of the surveys, the server 51 may generate the individual profile for the service providers 52 and 53. Alternatively, the server 51 may receive individual profiles for service providers generated elsewhere.

The potential service purchaser 54 may login into the server 51 to prepare the emotive profile. Alternatively, the emotive profile may be prepared elsewhere and provided to the server 51. In preferred embodiments, the potential service purchaser may save its emotive profile on the server 51. Upon request, the potential service purchaser 54 may be provided with a list of compatible service providers based on the correlation of the potential service purchaser's emotive profile and the individual profiles of the service providers. The system 50 may also facilitate communication between the service provider and the service purchaser either directly or through the server. Examples of communications include, but are not limited, exchange of electronic mail, web pages, electronic documents, photographs, video messages, answers to inquiries, phone calls and combinations thereof. Finally, the server 51 may provide service providers 52 and 53, and third parties 55 with feedback information. Of course, it will be understood that all communications between different parties are preferably encrypted in order to safeguard the transmitted private information.

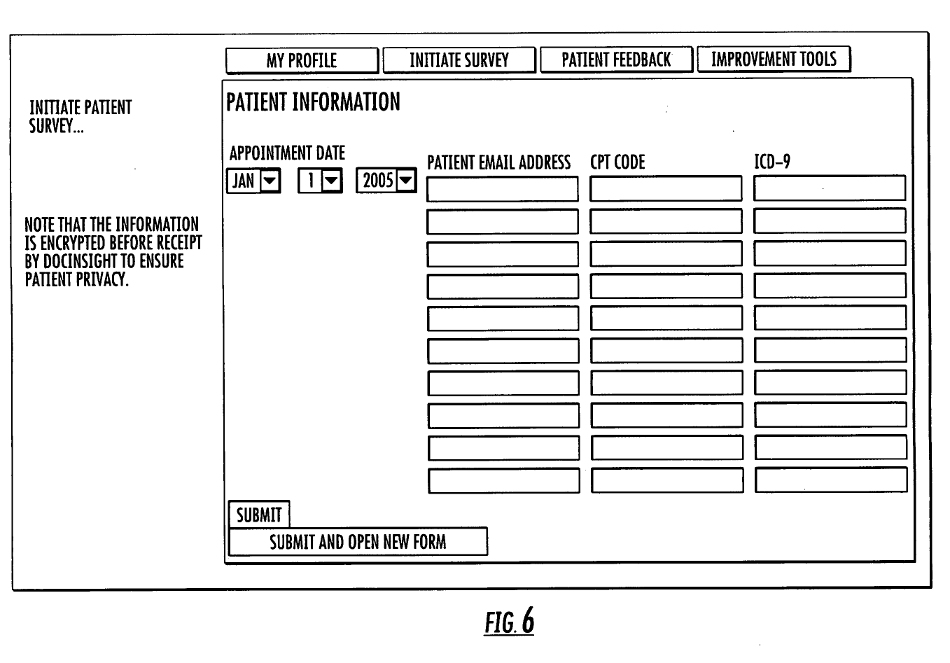

By way of non-limiting example, the methods described herein are particularly suitable for connecting physicians and patients. In the first step, a doctor or the doctor's assistant initiates a past patient survey by filing out a form such, as for example, is shown in FIG. 6. The form includes a date of appointment, past patient's contact information, and optionally a Current Procedural Terminology (CPT) code and an International Classification of Diseases (ICD) code. The CPT code describes medical, surgical, and diagnostic services while the ICD code describes signs, symptoms, injuries, diseases and conditions. Including the CPT and ICD codes enable physicians and, in some cases, third parties to compare survey results among past patients who received the same or similar treatment. In a preferred embodiment, the form is encrypted before it leaves the physician's office to ensure past patients' privacy. Encryption may be achieved by any method known and used in the art.

The surveys are then sent out to past patients that are listed on the form. The surveys ask the past patients to assign an emotive satisfaction value to pre-selected attributes based on the patient's experience with the physician. In addition, the surveys may ask past patients whether they would recommend the physicians and may ask past patients to provide a quick description of their overall experience. In a preferred embodiments, the surveys may include a number of phrases that describe a range of overall experiences and past patients may select the most applicable phrase. Examples of such phrases include, but are not limited to, knowledgeable, friendly, a true professional; compassionate, caring, and very thorough; concise, direct, and informative; aware, open-minded, really listens to me; or experienced, understanding, instructive.

The completed surveys are analyzed to create individual profiles for physicians. The individual profiles preferably include a measure of past patients' satisfaction, ESRV, and marketing information about the physician that may help a potential patient in selecting the physician. Such marketing information may include, but is not limited to, contact information, business hours, hospital affiliations, physician's credentials, board certification, years of experience, gender, specialty, residency, positions held, hours, additional languages spoken, medical philosophy and combinations thereof. The marketing information may be entered manually or imported from a database. In one embodiment, the physician's marketing information is selected from board certification, office location, medical philosophy, languages spoken, religious affiliations, office hours and contact information.

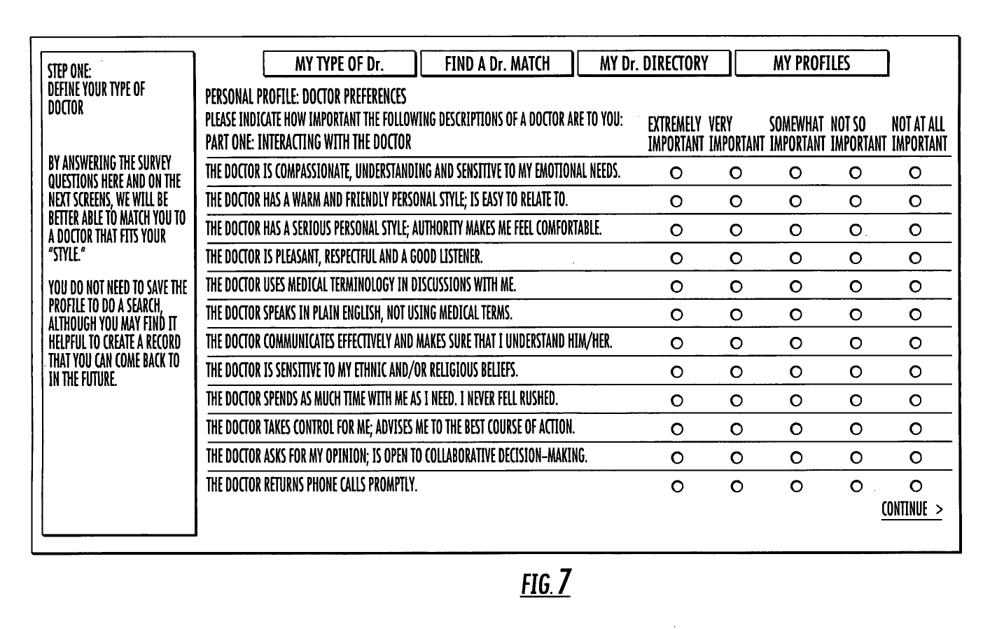

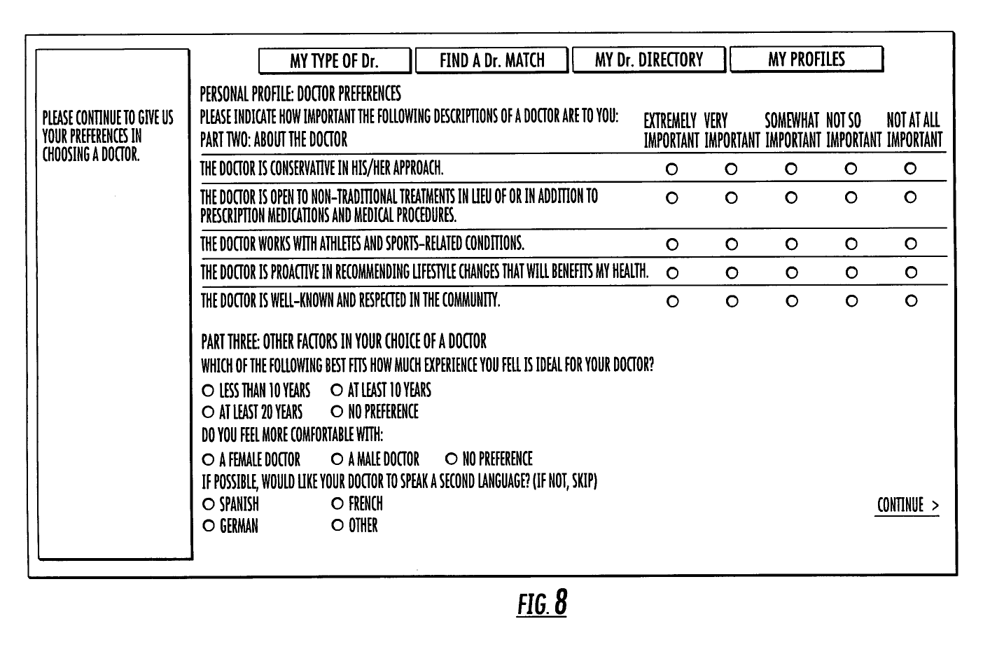

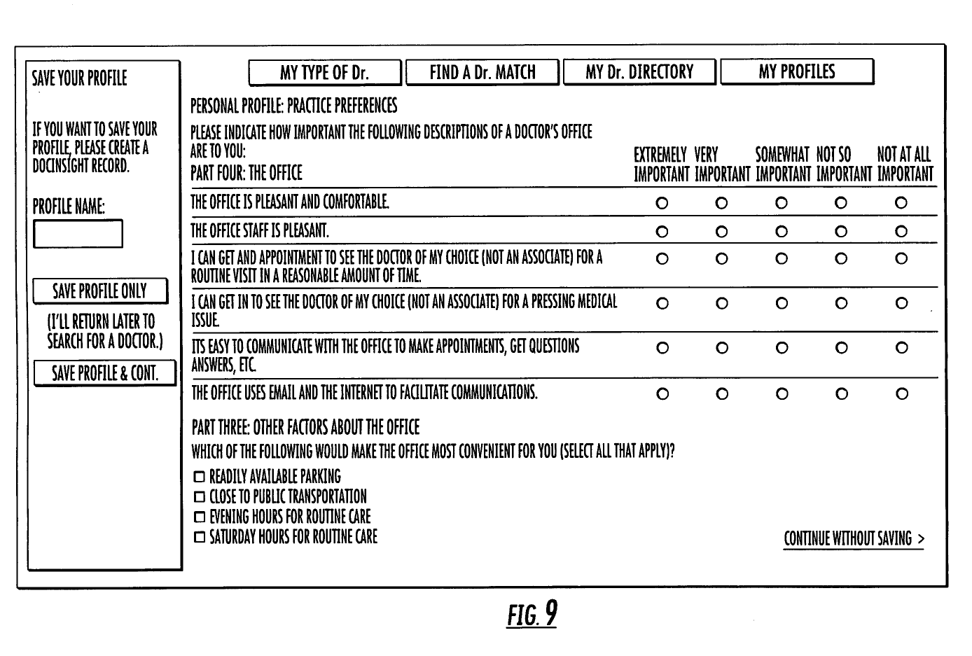

Upon connecting to the server, a new patient is prompted to create a personal profile comprising a patient's emotive profile. The emotive profile is used to better match a patient with doctors that fit the patient's personal style. The survey includes a number of queries that ask the patient to assign importance values to pre-selected attributes. These attributes allow the patient to indicate his or her preferences in regard to interacting with the physician, the physician's personal style, the physician's practice and office. Sample questionnaires are presented in FIGS. 7-10. The potential patient may save this personal profile on the server. In addition, a potential patient may include into the personal profile other personally relevant factors that may affect their choices such as, for example, whether the patient feels more comfortable with a male or a female physician, whether the patient feels more comfortable with a young or a more experienced physician, etc. Finally, the personal profile may include demographic information about the potential patient.

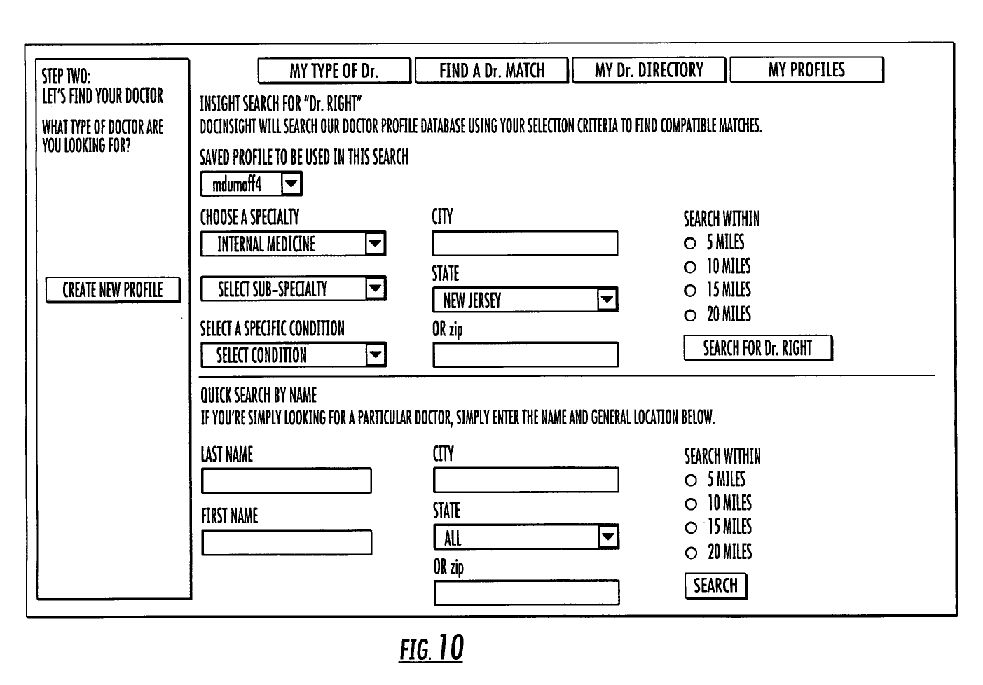

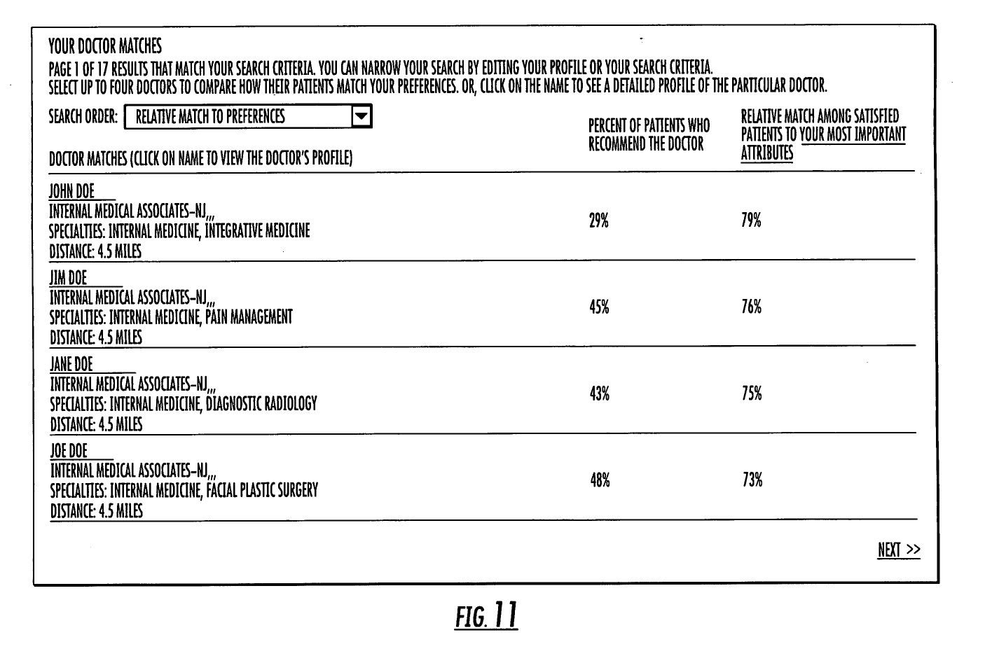

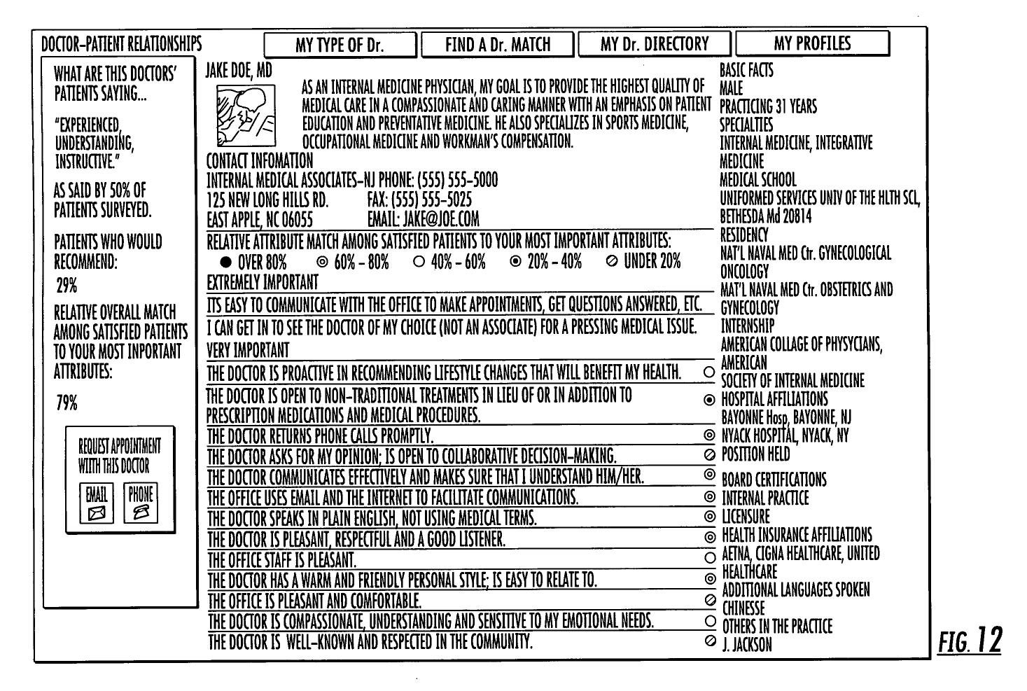

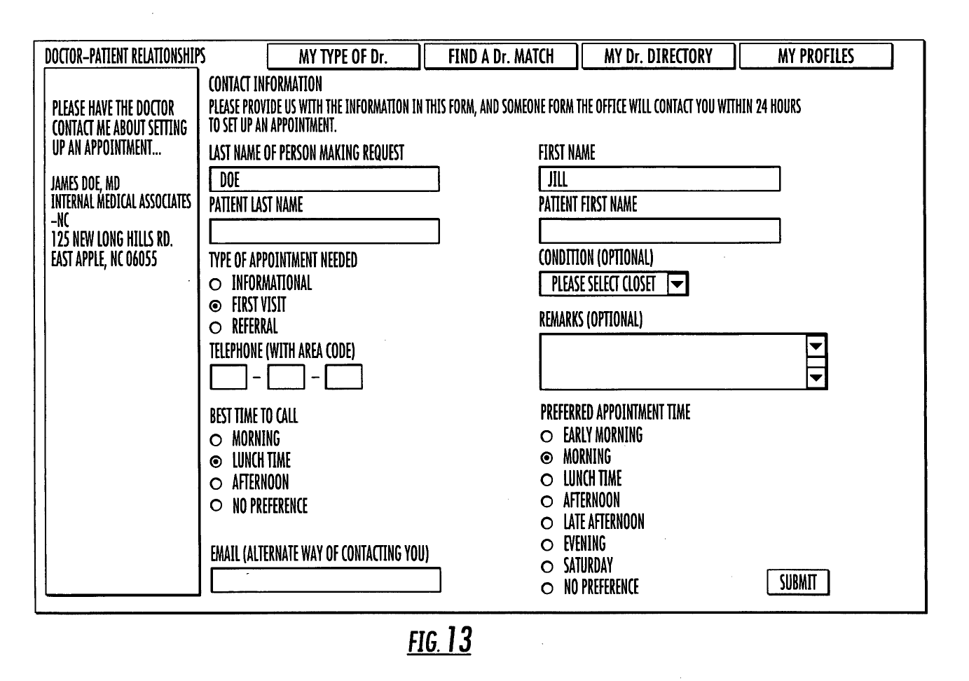

After preparing the emotive profile, the potential patient can search the doctor by other selection criteria such as specialty or sub-specialty, location, condition, name or by combinations thereof as shown in FIG. 10. The patient is then presented with a list of compatible doctors, as shown, for example, in FIG. 11, prepared based on correlation of the physician's individual profiles with the potential patient's emotive profile in combination with other selection criteria. Upon selecting a physician from the list, the potential patient may be presented with relevant parts of physician's personal profile that includes basic facts about the physician, contact information, a statement from the physician, the list of the attributes that the patient rated above a pre-set importance value and the ratings of the physicians on those attributes by past patients, and so forth. FIG. 12 presents one example of information presented to a potential patient. In the final step, the patient is enabled to initiate contact with physicians either by telephone or by sending an email form, one embodiment of which as shown in FIG. 13. In one embodiment, the potential patient may be enabled to attach his or her medical history files.

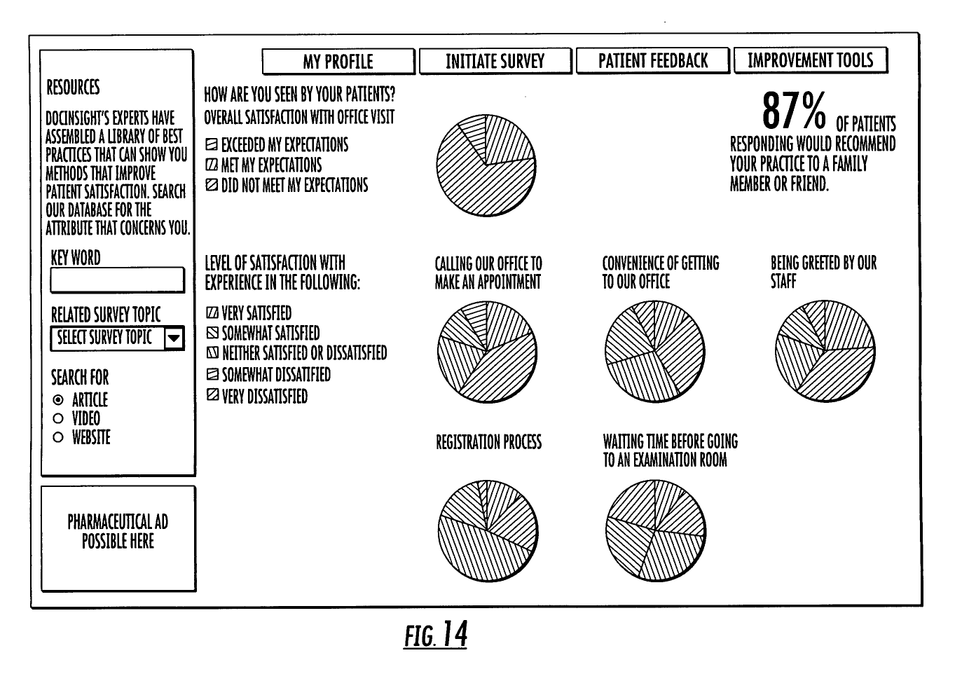

As described above, the methods described herein are useful in providing feedback to service providers. In one embodiment, a physician may be presented with feedback from past patients surveys. In a preferred embodiment, such as shown in FIG. 14, the feedback may comprise of pie charts showing the level of satisfaction of past patients with various attributes of physician's practice. In addition, physicians may be able to access a library of best practices that show physicians continuous improvement methods that improve patient satisfaction.

In addition, third parties may be presented with relevant information generated by practicing the methods disclosed herein. For example, health insurers or health plans may be able to access patients satisfaction with the physicians in their networks, measure the relations between patient satisfaction with improved outcomes of treatment, measure the relation between the patient satisfaction with improved compliance, measure physicians performance, understand the patients' values and preferences to drive product development, and patients retention and acquisition, among many other potential uses. Employers that provide health insurance to employees may use the methods disclosed herein to assess an employee's satisfaction with the physicians, measure an employee's access to timely care, measure the monetary impact of improving the employees, satisfaction with health care, increase employee satisfaction, and reduce the number of sick days, among many other potential uses. Providers of medical malpractice insurance may also be able to benefit from information obtained through practicing methods described herein. They may use the methods to ensure that the physicians practice the safest techniques, patients form trusting relationships with physicians, and that the patients are satisfied with treatment outcome, among other things.

Furthermore, third parties may employ embodiment of method to post market monitor its products. By way of a non-limiting example, a pharmaceutical company may post-market monitor its drugs. In one embodiment, a pharmaceutical company may send out surveys to monitor side effects of its drugs. Companies may use communications plan designed to improve prescribing physician and individual knowledge of the relative risks and benefits of the product for that defined patient population while prospective and confirmatory trials were conducted. The goal of post-market drug monitoring need not be limited to safety but can also include the ability of doctors and patients to choose medicines and treatments. For example, a patient may be notified when a drug that is prescribed to the patient may be replaced with a similar drug with some advantageous characteristics such as price, reduced likelihood of side effects, smaller dosage, etc.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A method for facilitating communication between service providers and service purchasers, the method comprising:
1) obtaining ranking of service providers by past service purchasers, the ranking comprising emotive satisfaction ratings of pre-selected attributes;
2) generating individual profiles of service providers comprising an emotive satisfaction rating value on pre-selected attributes for the service providers;
3) obtaining from a potential service purchaser an emotive profile comprising the potential service purchaser's assignment of an importance value to pre-selected attributes; and
4) providing a list of service providers to the potential service purchasers based on a correlation of the emotive profile with the emotive satisfaction rating values of service providers.

2. The method of claim 1 further comprising in response to the potential service purchaser selecting of a first service provider from the list, displaying individual profile for the first service provider comprising emotive satisfaction rating values.

3. The method of claim 2 wherein the emotive satisfaction rating values are displayed for attributes with the importance value higher than a relevance value.

4. The method of claim 1 further comprising enabling the potential service purchaser to contact service providers on the list.

5. The method of claim 1 further comprising providing feedback to service providers.

6. The method of claim 1 wherein the emotive satisfaction rating value of an attribute is an aggregate of all emotive satisfaction ratings of that attribute from surveys completed by past service purchasers.

7. The method of claim 1 further comprising in response to the potential service purchaser selecting of a first service provider from the list, displaying an information about the service provider wherein the information comprises a personal message, digital picture image, or a video message from the first service provider.

8. The method of claim 1 wherein the individual profile for service provider further comprises marketing information about the service provider.

9. The method of claim 8 wherein the potential service purchaser provides personally relevant factors.

10. The method of claim 9 wherein the list of service providers is further based on correlation of the service provider's marketing information and the potential service purchaser's personally relevant factors.

11. The method of claim 1 further comprising providing information to third parties.

12. The method of claim 1 further comprising enabling a third party to post-monitor or direct advertise its goods or services.

13. A system for facilitating communication between service providers and service purchasers comprising a bus system; a memory connected to the bus system wherein the memory includes a set of instructions; and a processor connected to the bus system, wherein the processor executes the set of instructions stored in memory to perform the method of claim 1.

14. A computer-readable medium having computer instructions, which when executed, carry out the method of claim 1.

15. A method for matching physicians with potential patients, the method comprising:
1) obtaining emotive satisfaction ratings on pre-selected attributes of physicians from past patients;
2) generating individual profiles for physicians comprising an emotive satisfaction rating value on pre-selected attributes;
3) obtaining from a potential patient an emotive profile comprising the potential patient's assignment of an importance value to pre-selected attributes, and
4) providing a list of physicians to the potential patient based on a correlation of the emotive profile and the emotive satisfaction rating values of physicians.

16. The method of claim 15 wherein the step of obtaining emotive satisfaction ratings on pre-selected attributes of physicians from past patients comprises:
1) enabling physician to provide to past patients surveys requesting emotive satisfaction ratings on pre-selected attributes; and
2) receiving the completed surveys.

17. The method of claim 15 wherein the emotive satisfaction rating value is an aggregate of all emotive satisfaction ratings.

18. The method of claim 15 wherein the physician's individual profile further comprise physician's marketing information.

19. The method of claim 18 wherein the potential patient further provides personally relevant factors.

20. The method of claim 19 wherein the list of physicians is further based on correlation of at least some of the physician's marketing information and the patient's personally relevant factors.

21. The method of claim 15 further comprising: in response to the potential patient's selection of a first physician from the list, displaying emotive satisfaction rating values received by the physician for attributes with the importance value higher than the first threshold value and at least some of physician's marketing information.

22. The method of claim 15 further enabling potential patient to contact service providers on the list.

23. The method of claim 15 further comprising providing information to health insurers, health networks, employers, or medical malpractice insurance providers.

24. The method of claim 15 further comprising providing feedback to physicians.

25. The method of claim 15 further comprising a step of enabling third parties to post-market monitor or direct advertise its products.
